(19) United States
(12) Patent Application Publication
(10) Pub. No.: US 2014/0002544 A1
(43) Pub. Date: Jan. 2, 2014

(54) HEIGHT-ADJUSTING APPARATUS FOR PRINTER

(71) Applicant: HON HAI PRECISION INDUSTRY CO., LTD., New Taipei (TW)

(72) Inventors: SZU-HAI HUANG, New Taipei (TW); PANG-YEN JAO, New Taipei (TW)

(73) Assignee: HON HAI PRECISION INDUSTRY CO., LTD., New Taipei (TW)

(21) Appl. No.: 13/895,503

(22) Filed: May 16, 2013

(30) Foreign Application Priority Data
Jun. 29, 2012 (CN) 2012102210819

(51) Int. Cl. B41J 25/308

(52) U.S. Cl. CPC B41J 25/3086
USPC 347/37

(57) ABSTRACT

An height-adjusting apparatus for a printing apparatus includes a bracket, a printing platform carrying the print head, an adjusting block, and an adjusting pole. The printing platform includes an accommodating box. The adjusting block includes a base and a ramped protrusion portion extending from the base. The adjusting pole passes through the accommodating box and the protrusion portion to fix the adjusting block between the bracket and the printing platform. When the adjusting pole is rotated, the protrusion portion moves in the accommodating box, and the ramp causes the printing platform to be raised or lowered as required on the bracket.

### BACKGROUND

1. Technical Field

The present disclosure relates to printing technology.

2. Description of Related Art

A typical printing apparatus, such as a printer or a photocopying machine, includes a bracket and a printing platform mounted on the bracket. A motor and a driving belt are mounted on the bracket to move the printing platform. A plurality of sliding blocks are mounted between the bracket and the printing platform to adjust a height of the printing platform. A damping member is mounted to the printing platform and the driving belt to decrease shocks and provide a “soft-start” moving function. However, the driving belt tends to be loosened on the damping member when the height of the printing platform is adjusted, and the printing apparatus malfunctions.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an adjusting apparatus for a printing apparatus, in accordance with an embodiment; the adjusting apparatus for a printing apparatus comprises a printing platform and an adjusting block.

FIG. 2 is an exploded, isometric view of the adjusting apparatus for printing apparatus of FIG. 1, viewed from another aspect.

FIG. 3 is an assembled view of the adjusting apparatus for the printing apparatus of FIG. 1.

FIG. 4 is a cross-sectional view of the adjusting apparatus for the printing apparatus of FIG. 3, taken along line IV-IV, with the printing platform being lifted up by the adjusting block.

FIG. 5 is a cross-sectional view of the adjusting apparatus for printing apparatus of FIG. 1, with the printing platform laid down by the adjusting block.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

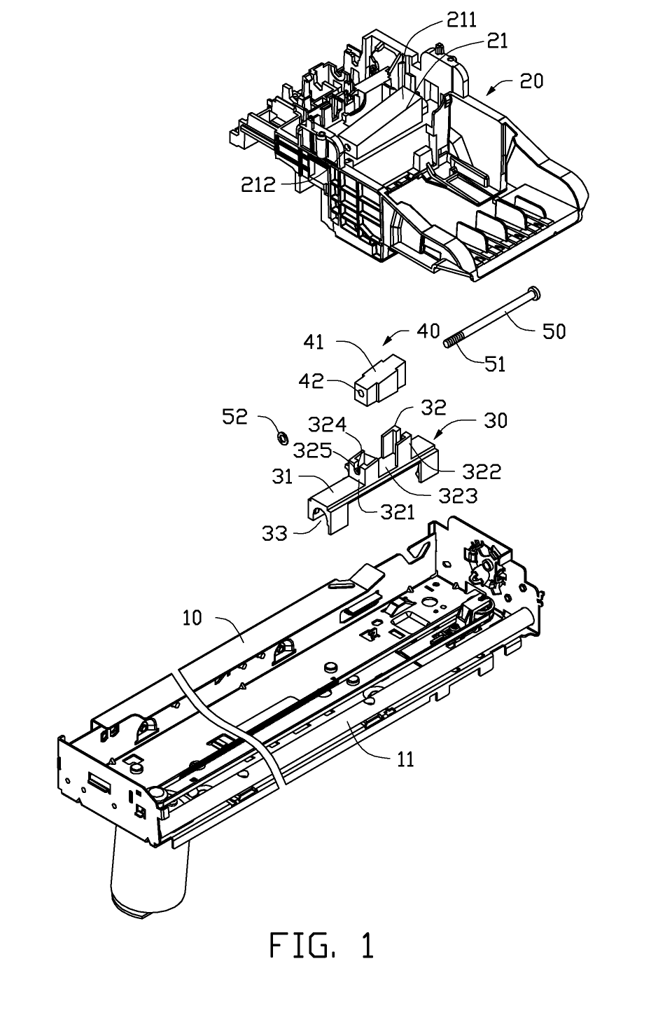

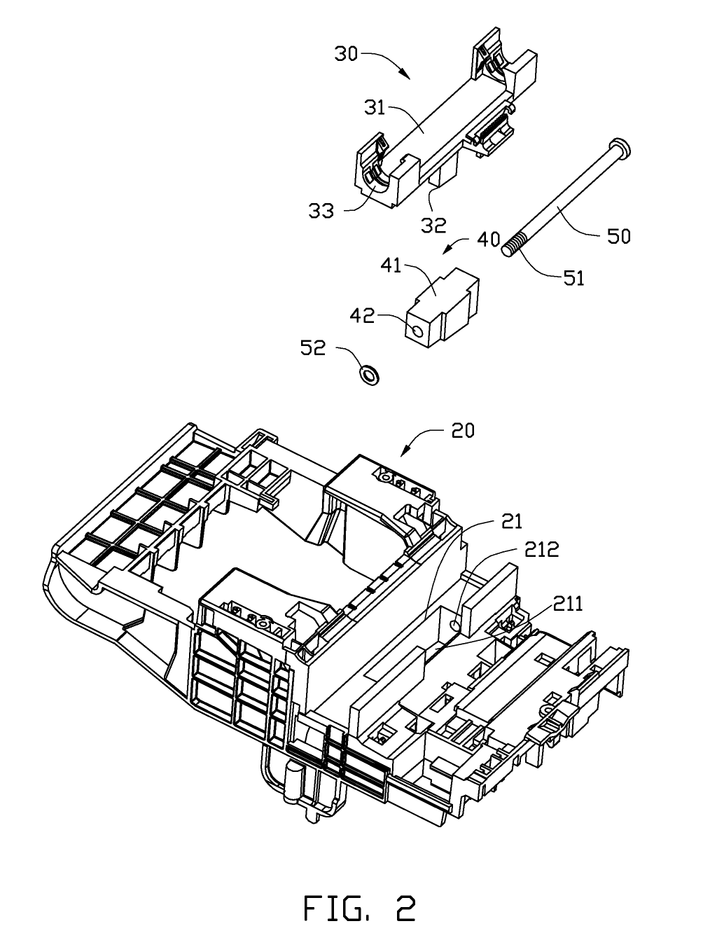

FIGS. 1 and 2 show an adjusting apparatus for printing apparatuses which includes a bracket 10, a printing platform 20 slidably fixed on the bracket 10 which carries the print head, and an adjusting block 30 slidably fixed on the bracket 10.

The adjusting block 30 includes a base 31, and a protrusion portion 32 extended from the base 31. The protrusion portion 32 includes a first sidewall 321, a second sidewall 322, and an accommodating space 323 corporately formed between the first sidewall 321 and the second sidewall 322. A damping block 40 is accommodated in the accommodating space 323. A diagonal surface 41 is formed on a top of the damping block 40. An accommodating box 21 is formed on the printing platform 20. A diagonal panel 211 is formed on a top of the accommodating box 21. An adjusting pole 50 passes through the accommodating box 21 and the protrusion portion 32 to movably fix the adjusting block 30 between the bracket 10 and the printing platform 20. A first sliding slot 324 is defined in each of the first sidewall 321 and the second sidewall 322. A first through hole 212 is defined in each of the two sides of the accommodating box 21. A second through hole 42 is defined in each of the two sides of the damping block 40. A plurality of outer threads 51 are formed on the adjusting pole 50. A locking ring 52 is mounted on a distal end of the adjusting pole 50. A plurality of inner threads 325 are formed in each of the two first sliding slots 324. A guiding pole 11 is mounted on the bracket 10. Two second sliding slots 33 are defined at a bottom of the base 31.

In one embodiment, a length of the protrusion portion 32 is less than that of the accommodating box 21 and less than that of the base 31. The length of the protrusion portion 32 is substantially equal to that of the damping block 40. A height of the first sidewall 321 is less than that of the second sidewall 322. The height of the second sidewall 322 is less than that of the damping block 40.

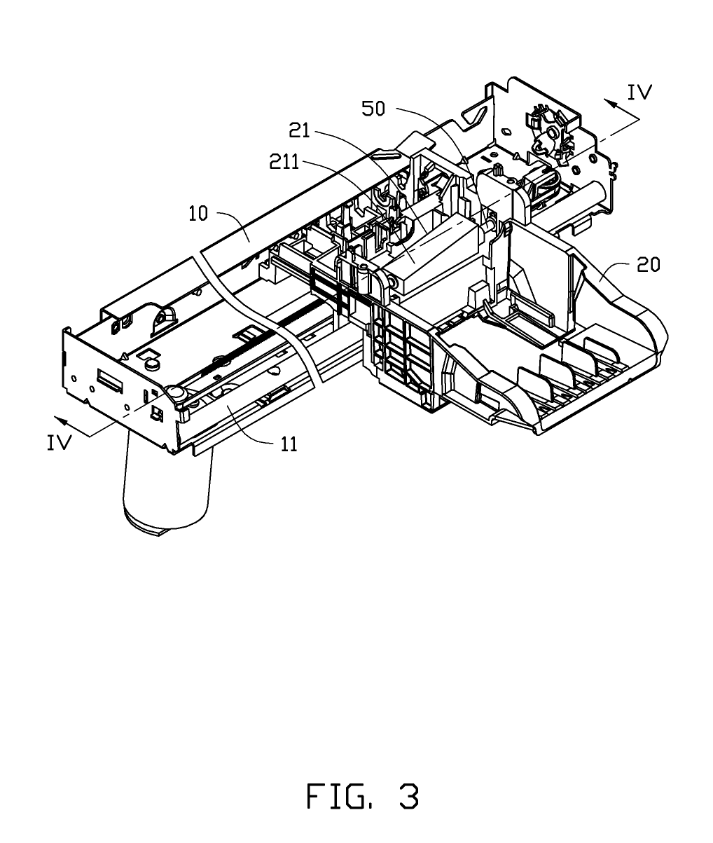

Referring to FIG. 3, in assembly, the guiding pole 11 passes through the two second sliding slots 33 in the base 31 to slidably mount the adjusting block 30 to the bracket 10. The damping block 40 is accommodated in the accommodating space 323. The two second through holes 42 in the damping block 40 are aligned with the two first sliding slots 324 in the first sidewall 321 and the second sidewall 322. The printing platform 20 is mounted onto the adjusting block 30 to accommodate the protrusion portion 32 in the accommodating box 21. The two first through holes 212 in the accommodating box 21 are aligned with the two first sliding slots 324. The adjusting pole 50 passes through the first through holes 212, the first sliding slots 324, and the second through holes 42. The locking ring 52 is mounted on the distal end of the adjusting pole 50 to fix the adjusting block 30 and the damping block 40 in place onto the printing platform 20. The diagonal surface 41 on the damping block 40 contacts the diagonal panel 211 on the accommodating box 21.

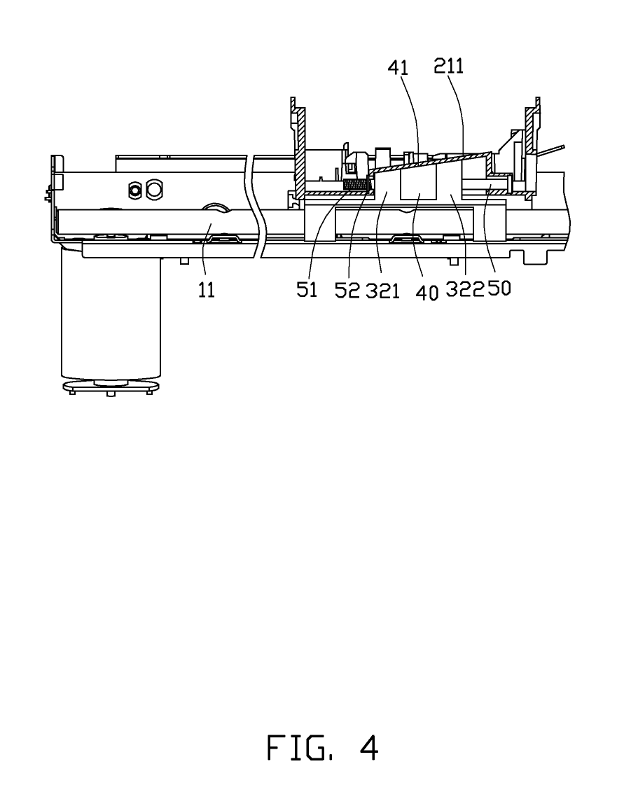

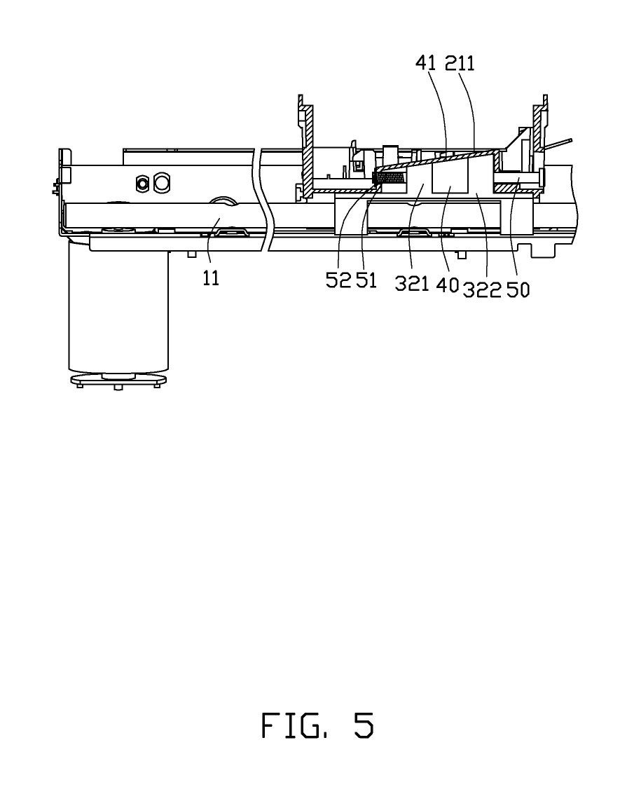

Referring to FIGS. 4 and 5, in use, the adjusting pole 50 can be rotated in a first direction and an opposite second direction. In one embodiment, the first direction is a clockwise direction, and the second direction is a counterclockwise direction. When the adjusting pole 50 is rotated along a first direction, the plurality of outer threads 51 on the adjusting pole 50 engage with the plurality of inner threads 325 in the first sliding slots 324. The adjusting pole 50 thus moves the protrusion portion 32 in a third direction in the accommodating box 21. The diagonal surface 41 moves toward the second direction and resists against the diagonal panel 211. The printing platform 20 is raised by the adjusting block 30 to a first height.

When the adjusting pole 50 is rotated along the second direction, the plurality of outer threads 51 engage with the plurality of inner threads 325 and move the protrusion portion 32 in a fourth direction in the accommodating box 21. The diagonal surface 41 moves in the fourth direction and withdraws support for the diagonal panel 211. The printing platform 20 is thus lowered by the adjusting block 30 to a second height. When the printing platform 20 falls to the second height, the diagonal surface 41 contacts the diagonal panel 211 again. In one embodiment, the locking ring 52 prevents the disengagement of the adjusting pole 50 from the first sliding slots 324 when the adjusting pole 50 is rotated. In one embodiment, the third direction is toward the left, and the fourth direction is toward the right. The second height is lower than the first height.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An adjusting apparatus for a printing apparatus comprising:
a bracket;
a printing platform slidably secured to the bracket, the printing platform comprising an accommodating box;
an adjusting block slidably secured to the bracket, the adjusting block comprising a base and a protrusion portion extended from the base; and
an adjusting pole configured to be passed through the accommodating box and the protrusion portion and to movably fix the adjusting block between the bracket and the printing platform;
wherein when the adjusting pole rotates, the protrusion portion moves in the accommodating box, and the printing platform is lifted up or lowered down by the adjusting block to adjust a height of the printing platform on the bracket.

2. The adjusting apparatus of claim 1, wherein when the adjusting pole rotates along a first direction, the protrusion portion moves toward a third direction in the accommodating box, the printing platform is lifted up by the adjusting block to a first height; and when the adjusting pole rotates along a second direction, the protrusion portion moves toward a fourth direction in the accommodating box, and the printing platform is lowered down by the adjusting block to a second height.

3. The adjusting apparatus of claim 2, wherein the first direction is a clockwise direction; the second direction is a counterclockwise direction; the third direction is toward the left; and the fourth direction is toward the right.

4. The adjusting apparatus of claim 2, wherein a length of the protrusion portion is less than a length of the accommodating box; and the second height is lower than the first height.

5. The adjusting apparatus of claim 1, wherein the protrusion portion comprises a first sidewall, a second sidewall, and an accommodating space is defined between the first sidewall and the second sidewall; a damping block is accommodated in the accommodating space; a diagonal surface is disposed on a top of the damping block; a diagonal panel is disposed on a top of the accommodating box; and when the protrusion portion moves in the accommodating box, the diagonal surface on the damping block moves relative to the diagonal panel on the accommodating box.

6. The adjusting apparatus of claim 5, wherein the length of the protrusion portion is less than a length of the base; the length of the protrusion portion is substantially equal to a length of the damping block; a height of the first sidewall is less than a height of the second sidewall; and the height of the second sidewall is less than a height of the damping block.

7. The adjusting apparatus of claim 6, wherein each of the first sidewall and the second sidewall comprises a first sliding slot; the accommodating box comprises two first through holes in two sides of the accommodating box respectively; the damping block comprises two second through holes in two sides of the damping block; and the adjusting pole passes through the first through holes, the first sliding slots, and the second through holes to fix the adjusting block and the damping block onto the printing platform.

8. The adjusting apparatus of claim 7, wherein the adjusting pole comprises a plurality of outer threads; each of the two first sliding slots comprises a plurality of inner threads; when the adjusting pole rotates, the plurality of outer threads on the adjusting pole engage with the plurality of inner threads in the first sliding slots, and the adjusting pole moves the protrusion portion in the accommodating box.

9. The adjusting apparatus of claim 8, wherein the adjusting pole comprises a locking ring mounted on a distal end of the adjusting pole; and the locking ring protects the adjusting pole from falling off the first sliding slots when the adjusting pole is rotated.

10. The adjusting apparatus of claim 9, further comprising a guiding pole mounted on the bracket; wherein the base comprises two second sliding slots at a bottom of the base; and the guiding pole passes through the two second sliding slots to mount the adjusting block to the bracket.

11. An adjusting apparatus for a printing apparatus comprising:
a bracket;
a printing platform slidably secured to the bracket, the printing platform comprising an accommodating box;
an adjusting block slidably secured to the bracket, the adjusting block comprising a base and a protrusion portion extended from the base; and
an adjusting pole configured to be passed through the accommodating box and the protrusion portion and to movably fix the adjusting block between the bracket and the printing platform;
wherein the adjusting pole rotates to move the protrusion portion in the accommodating box; and the printing platform is lifted up or lowered down between a first height and a second height by the adjusting block.

12. The adjusting apparatus of claim 11, wherein when the adjusting pole rotates along a first direction, the protrusion portion moves toward a third direction in the accommodating box to lift up the printing platform to the first height; and when the adjusting pole rotates along a second direction, the protrusion portion moves toward a fourth direction in the accommodating box to lower down the printing platform to the second height.

13. The adjusting apparatus of claim 12, wherein the first direction is a clockwise direction; the second direction is a counterclockwise direction; the third direction is toward the left; and the fourth direction is toward the right.

14. The adjusting apparatus of claim 11, wherein a length of the protrusion portion is less than a length of the accommodating box; and the second height is lower than the first height.

15. The adjusting apparatus of claim 11, wherein the protrusion portion comprises a first sidewall, a second sidewall, and an accommodating space is defined between the first sidewall and the second sidewall; a damping block is accommodated in the accommodating space; a diagonal surface is disposed on a top of the damping block; a diagonal panel is disposed on a top of the accommodating box; and when the protrusion portion moves in the accommodating box, the diagonal surface on the damping block moves relative to the diagonal panel on the accommodating box.

16. The adjusting apparatus of claim 15, wherein a length of the protrusion portion is less than a length of the base; the length of the protrusion portion is substantially equal to a length of the damping block; a height of the first sidewall is less than a height of the second sidewall; and the height of the second sidewall is less than a height of the damping block.

17. The adjusting apparatus of claim 16, wherein each of the first sidewall and the second sidewall comprises a first sliding slot; the accommodating box comprises two first through holes in two sides of the accommodating box respectively; the damping block comprises two second through holes in two sides of the damping block; and the adjusting pole passes through the first through holes, the first sliding slots, and the second through holes to fix the adjusting block and the damping block onto the printing platform.

18. The adjusting apparatus of claim 17, wherein the adjusting pole comprises a plurality of outer threads; each of the two first sliding slots comprises a plurality of inner threads; when the adjusting pole rotates, the plurality of outer threads on the adjusting pole engage with the plurality of inner threads in the first sliding slots, and the adjusting pole moves the protrusion portion in the accommodating box.

19. The adjusting apparatus of claim 18, wherein the adjusting pole comprises a locking ring mounted on a distal end of the adjusting pole; and the locking ring protects the adjusting pole from falling off the first sliding slots when the adjusting pole is rotated.

20. The adjusting apparatus of claim 19, further comprising a guiding pole mounted on the bracket; wherein the base comprises two second sliding slots at a bottom of the base; and the guiding pole passes through the two second sliding slots in the base to mount the adjusting block to the bracket.
